(19) United States
(12) Patent Application Publication
(10) Pub. No.: US 2013/0135338 A1
(43) Pub. Date: May 30, 2013

(54) METHOD AND SYSTEM FOR SUBPIXEL-LEVEL IMAGE MULTITONING

(71) Applicants: Jennifer L. Gille, Menlo Park, CA (US); Manu Parmar, Sunnyvale, CA (US); Umamahesh Srinivas, State College, PA (US)

(72) Inventors: Jennifer L. Gille, Menlo Park, CA (US); Manu Parmar, Sunnyvale, CA (US); Umamahesh Srinivas, State College, PA (US)

(73) Assignee: QUALCOMM MEMS TECHNOLOGIES, INC., San Diego, CA (US)

(21) Appl. No.: 13/307,604

(22) Filed: Nov. 30, 2011

(51) Int. Cl. G09G 5/02

(52) U.S. Cl. 345/596

(57) ABSTRACT

This disclosure provides systems, methods and apparatus, including computer programs encoded on computer storage media, for displaying high resolution images using examples of a halftoning method based on diffusing quantization error from a subpixel displaying a color to one or more subpixels that display a different color.

### TECHNICAL FIELD

This disclosure relates to the field of image multitoning for digital display devices and more particularly to electromechanical systems based display devices.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Digital images are commonly quantized into a plurality of grayscale or color levels for printing or displaying the digital images on a medium with limited tonescale resolution. Various techniques have been developed to reduce errors associated with quantization and to create the illusion of continuous-tone imagery in printed and displayed images.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a reflective display device including a plurality of pixels, each pixel including a plurality of subpixels, each of the plurality of subpixels configured to display black and at least one color in a display color space associated with the display device. The apparatus further includes a processor configured to communicate with the display device, the processor configured to process incoming image data. In various implementations, the processor is further configured to: convert the incoming image data to converted image data expressing the incoming image in the display color space; map the converted image data to the plurality of subpixels by assigning a value for each of the plurality of subpixels; and for each subpixel: quantize the value, the quantization associated with a quantization error for each subpixel; and diffuse the quantization error to one or more neighboring subpixels that display a color different from the color displayed by the subpixel to provide a diffused quantized color value for the one or more neighboring subpixels. In various implementations, each pixel can include three or more subpixels. For example, in some implementations, each pixel can include four subpixels. In various implementations, each subpixel can include two or more movable mirror elements. In various implementations, the movable mirror elements can have different reflective areas. In various implementations, the processor can diffuse quantization error to the neighboring subpixels based at least in part on the reflective areas of the movable mirror elements. In various implementations, each subpixel can display two bits per color channel. In various implementations, each display can display a color selected from a set of colors which when combined displays white.

Another innovative aspect of the subject matter described in this disclosure can be implemented in an apparatus including a reflective display device including a plurality of pixels, each pixel including a plurality of subpixels. Each of the plurality of subpixels is configured to display black and a color in a color space associated with the reflective display device. The reflective display device can display an image by mapping the image data to the plurality of subpixels. The apparatus includes a means for quantizing the mapped image data. In various implementations, the quantization is associated with a quantization error for each subpixel. The apparatus further includes a means for diffusing the quantization error to one or more neighboring subpixels that display a color different from the color displayed by the subpixel. In various implementations, the reflective display device can include at least one interferometric modulator. In various implementations, the quantizing means can include a processor configured to communicate with the reflective display device. In various implementations, the diffusing means can include a processor configured to communicate with the reflective display device.

One innovative aspect of the subject matter described in this disclosure is a method for diffusing quantization error in a display device. The method includes converting incoming image data to converted image data expressing the incoming image in a display color associated with a display device. In various implementations, the display device can include a plurality of pixels, each pixel including a plurality of subpixels configured to display black and at least one color in the display color space. The method further includes mapping the converted image data to the plurality of subpixels by assigning a value in the display color space for each of the plurality of subpixels. The method includes quantizing the value assigned to each subpixel, the quantization associated with a quantization error for each subpixel and diffusing the quantization error to one or more neighboring subpixels that display a color different from the color displayed by the subpixel to provide diffused quantized color values for the one or more neighboring subpixels. In various implementations, the quantization error can be diffused to one or more neighboring subpixels that display a color having one or more of: a different hue, a different saturation, or a different brightness from the color display by the subpixel. In various implementations, a non-transitory computer-readable medium can include executable instructions that when executed by one or more processors, performs the method of diffusing quantization error in a display device. In another innovative aspect, computer programs encoded on computer storage media can implement examples of the methods for diffusing quantization error.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a display device including a pixel array having a plurality of display pixels.

FIG. 9B shows an example method of distributing quantization error to neighboring pixels displaying the same color.

FIGS. 10A and 10B show examples of display devices including a plurality of pixels, with each pixel including a plurality of subpixels.

FIG. 10C shows an example representation of a pixel in the XYZ color space.

FIG. 10D shows an example method of distributing quantization error to neighboring subpixels.

FIG. 10E illustrates a flowchart that describes an example method of performing error diffusion on a subpixel array.

FIG. 11 shows an example of a cross-section of an implementation of a display device including an array of electromechanical systems devices.

FIGS. 12A and 12B show an example of a display device that can display 2-bit color.

FIG. 12C shows an example method of distributing quantization error to neighboring subpixels in a display device that can display 2-bit color.

FIGS. 13A and 13B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (for example, video) or stationary (for example, a still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (for example, display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In digital imaging using a binary display (such as electromechanical systems based display devices) that has only two color levels per color channel (for example, color and very little color (black), or pixel turned on and pixel turned off), methods such as halftoning or spatial dithering can be used to create the illusion of continuous-tone images. Multitoning is an extension of certain halftoning methods for systems that can display more than two color levels per color channel. Generally, halftoning and multitoning methods have been developed to display or print high resolution images (such as images having 24 bits per pixel, 8 bits per color channel) on a medium (such as a display device) having lower resolution (for example, 2 or 4 bits per color channel). Examples of halftoning methods include dithering and error diffusion.

For example, to display images with 8 bits (for example, 256 color levels) per color channel on a medium having 2 or 4 bits per color channel, a method referred to as color quantization can be used to reduce the number of distinct color levels (per channel) possible in the image (for example, 256 color levels for 8 bits) to the number of distinct color levels that can be produced by the medium (for example, 4 color levels for 2 bits). The image color (in a color channel) of a pixel can be mapped to the closest color producible by the color channel in the medium. Since the medium's closest color typically is not the exact color of the image pixel, color quantization is generally associated with a quantization error. Halftoning or multitoning methods including error diffusion rely on distributing the quantization error in a particular pixel to the neighboring pixels.

In certain implementations, each pixel of the display device can include a plurality of subpixels. In certain such implementations, a high resolution display device can be provided by using a halftoning method based on diffusing quantization error from a subpixel displaying a color (for example, red) to one or more neighboring subpixels that display a different color (for example, green, a different hue of red, a brighter red, a de-saturated red, etc.) instead of (or in addition to) diffusing quantization error to one or more neighboring display pixels/subpixels that display the same color.

Each subpixel can include one or more interferometric modulators and are configured to display black (for example, when the interferometric modulators included in the subpixel are turned-off) and one or more colors (for example, red, yellow, magenta, green, blue, cyan, etc.) In some implementations, each subpixel of the display device can include three interferometric modulators, two of which can be coupled together such that each subpixel can display 2 bits of data per color channel. The two coupled interferometric modulators can provide the most significant bit (MSB) for the color and the third interferometric modulator can provide the least significant bit (LSB) for the color. In such implementations, the quantization error can be diffused to the different interferometric modulators that are included in the neighboring subpixels with different weights. For example, the quantization error can be diffused to the two coupled interferometric modulators of the neighboring subpixels with a higher weight than the third interferometric modulator of the neighboring subpixels. Accordingly, certain implementations of the halftoning methods described herein may advantageously provide versatile ways of diffusing quantization error for display devices with a wide range of pixel and/or subpixel configurations.

Particular implementations of the subject matter described in this disclosure can be implemented to realize one or more of the following potential advantages. It can be possible to display high resolution continuous-tone digital images by diffusing quantization error from a subpixel configured to display a color to a neighboring subpixel configured to display a different color in a display device having a de-saturated color space than in a display device having a color space, for example, sRGB color space. In certain display devices having a de-saturated color space, the colors are not pure and can include contributions from other colors or wavelengths. For example, a red color displayed by a subpixel in a display device having a de-saturated color space can include contribution from other colors, such as, green and blue. Thus, diffusing errors from a subpixel that displays a de-saturated red to a subpixel that displays de-saturated green can yield an acceptable result as compared to diffusing errors from a subpixel that displays pure red to a subpixel that displays pure green. Accordingly, certain implementations of the method of diffusing quantization error from a subpixel configured to display a color to a neighboring subpixel configured to display a different color may be advantageously used in a display device having a de-saturated color space. Also, high resolution continuous-tone digital images can be provided for color spaces using one or more de-saturated colors. Diffusing quantization error to a neighboring subpixel as described herein can also provide higher spatial resolution in the horizontal as well as the vertical direction in an array of pixels. It may also be possible to enhance the sharpness of the displayed images by using the error diffusing methods described herein.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

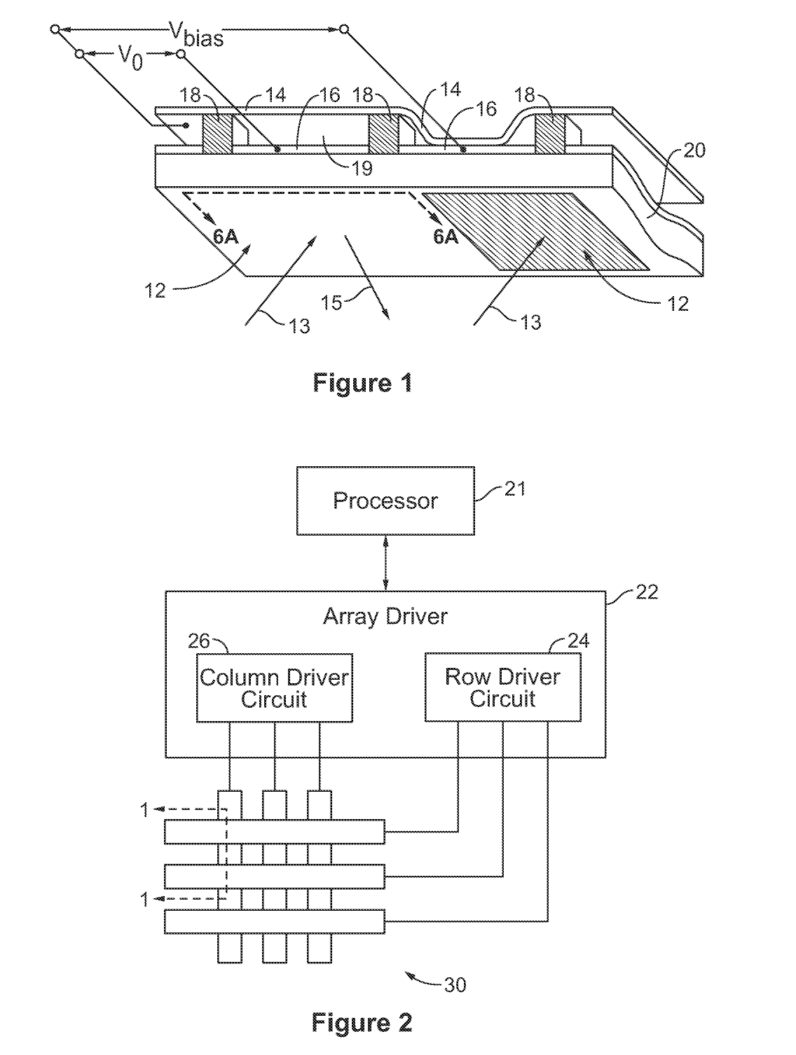

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, for example, to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (for example, of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

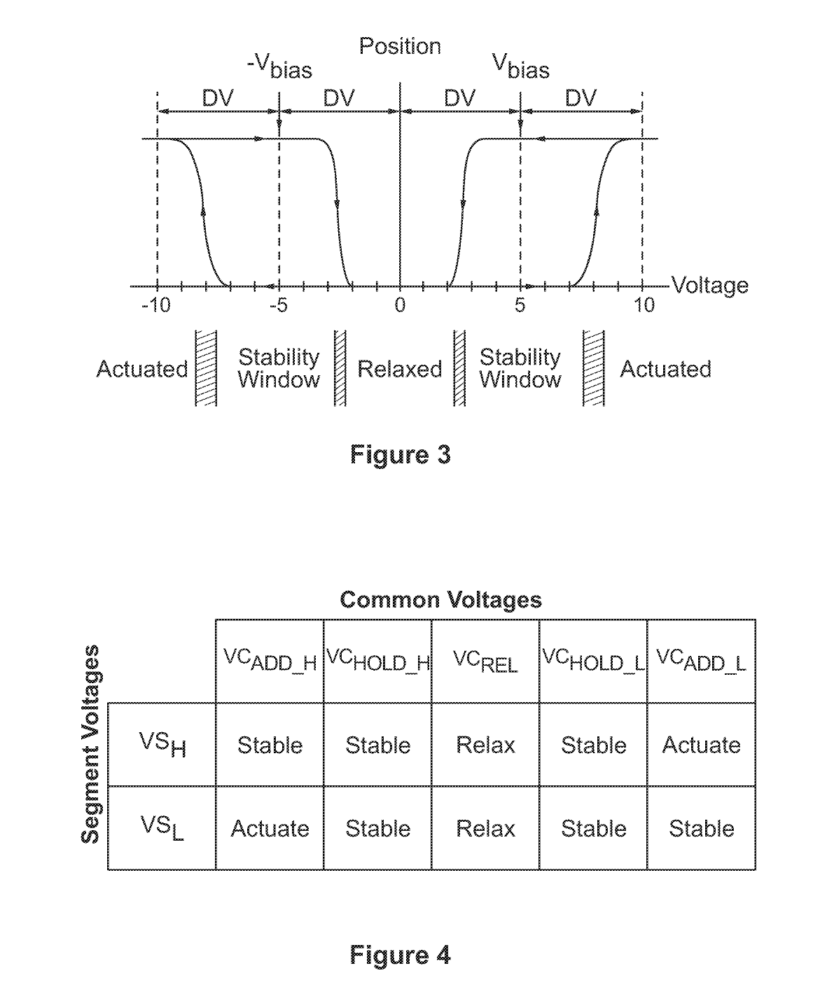

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

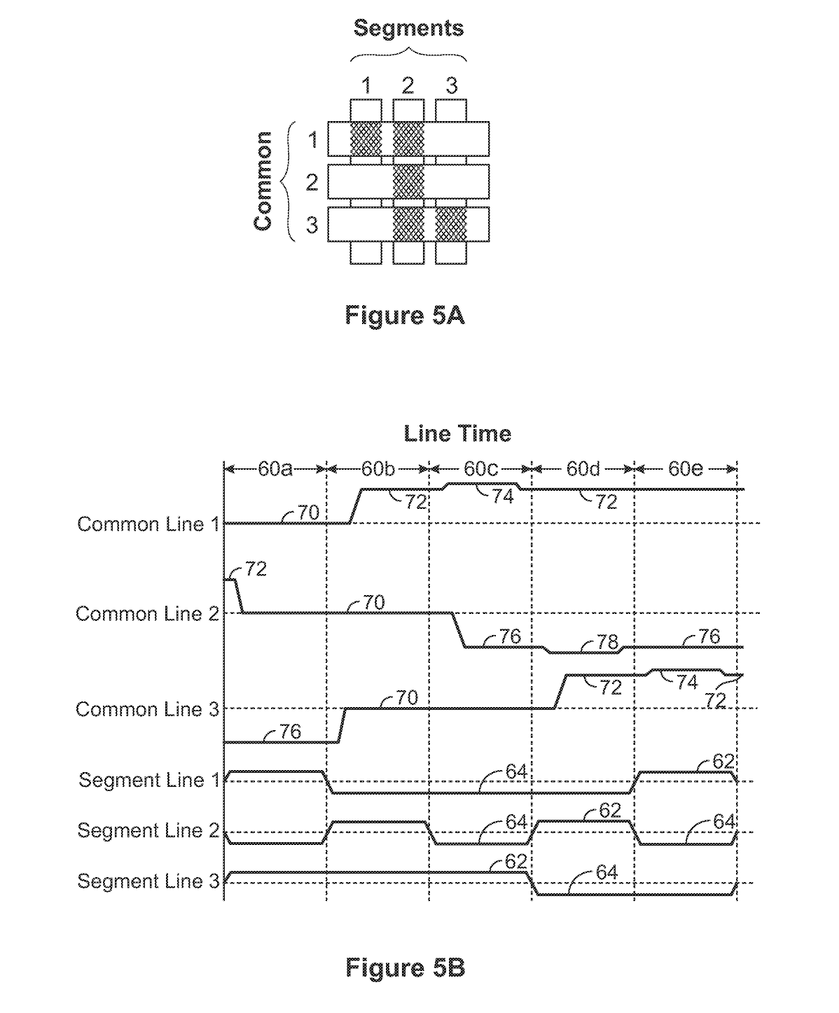

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

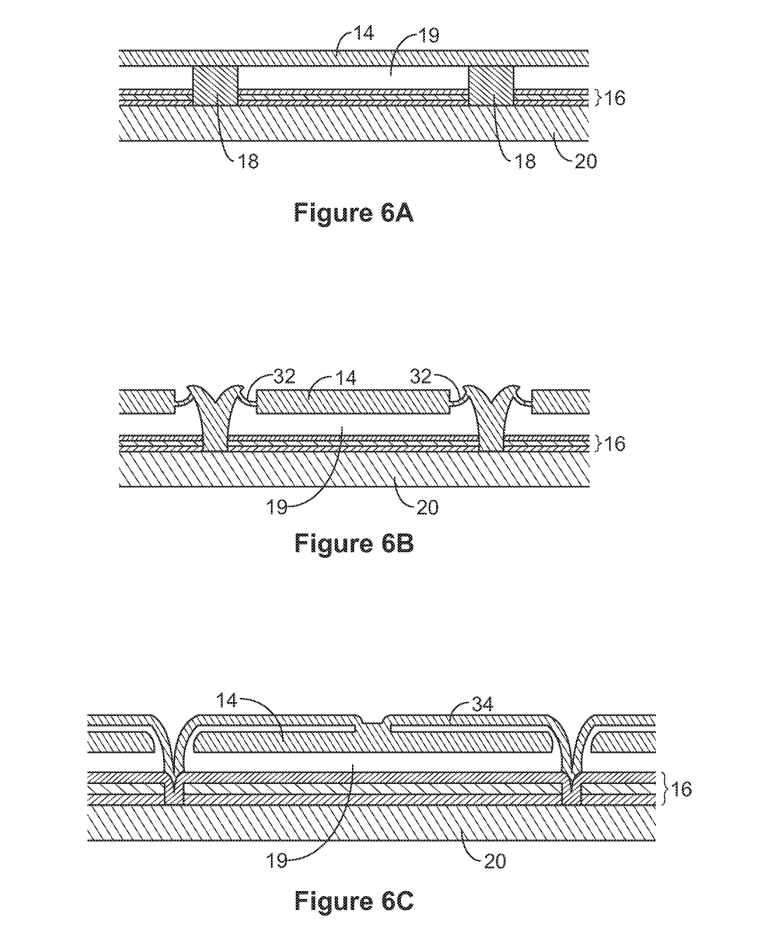

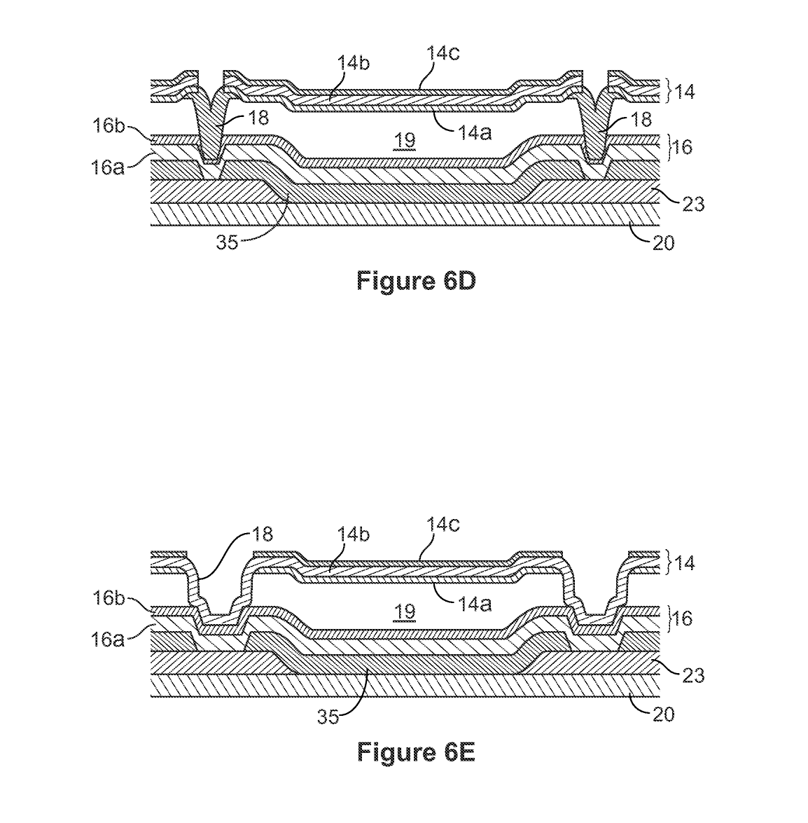

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

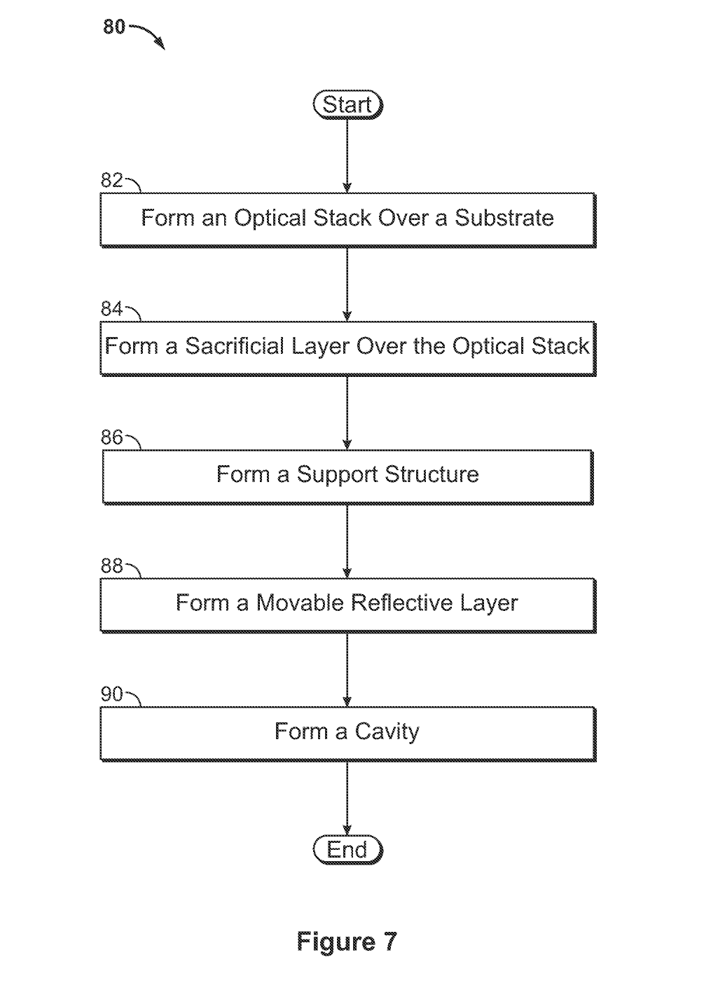

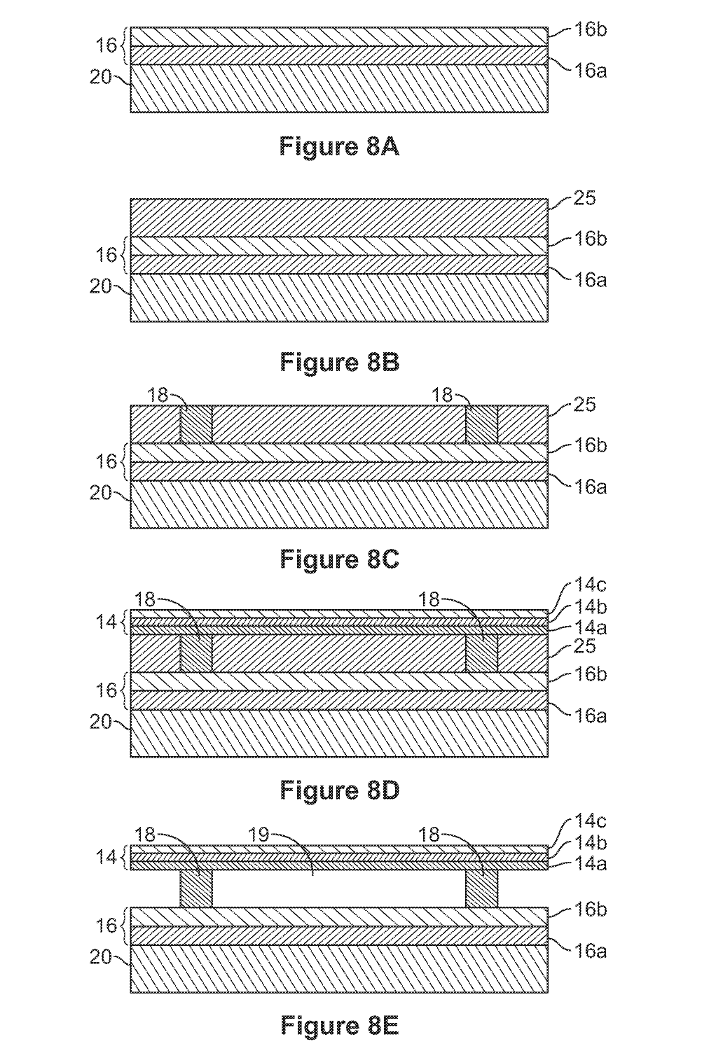

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (for example, one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

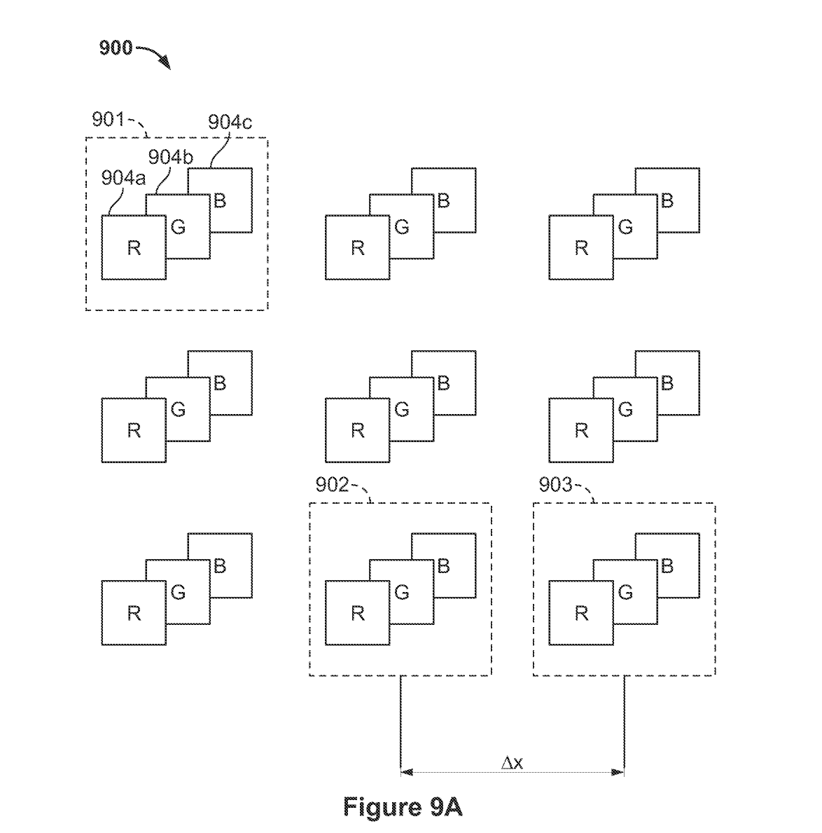

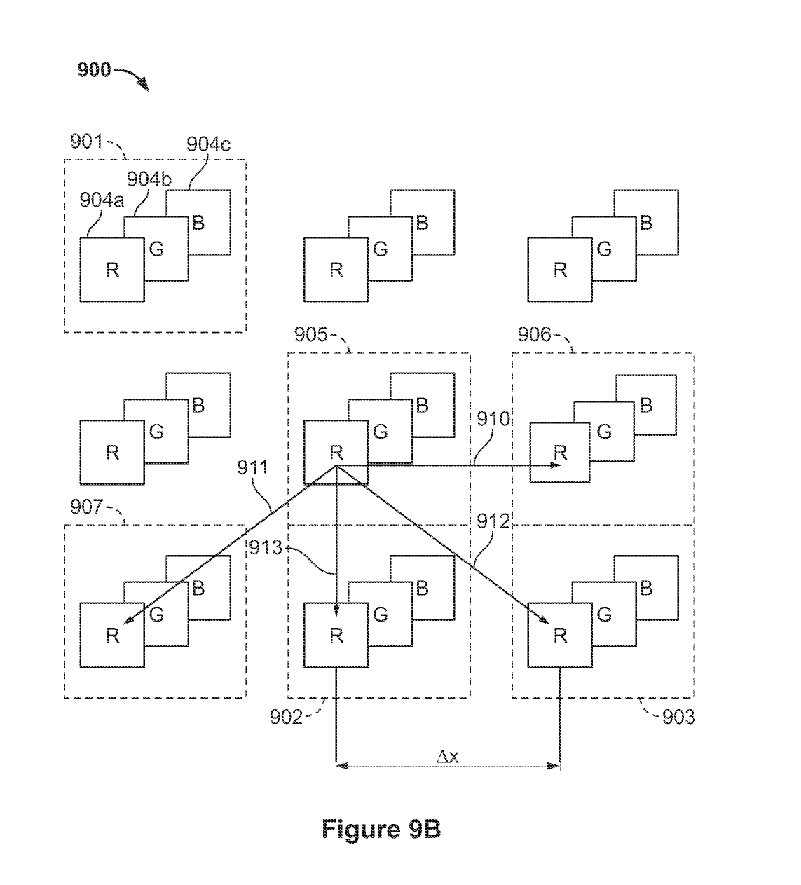

FIG. 9A shows an example of a display device including a pixel array 900 having a plurality of display pixels. The pixel array 900 shown in FIG. 9A is a 3×3 portion of a larger pixel array. In various implementations, the display device can include an array of 512×512 display pixels. In various implementations, the display device can include an array of 1024×1024; 768×1024; or 1920×1080 display pixels. In FIG. 9A, three representative display pixels 901, 902 and 903 are indicated. Each display pixel can include a plurality of subpixels (e.g., subpixels 904a, 904b, and 904c in display pixel 901) that are configured to display a color (for example, red, green, and blue in this example). In FIG. 9A, the pixel pitch, which is the distance between two adjacent pixels (for example, the distance between the pixels 902 and 903 in FIG. 9A), is given by Δx. In some display devices, the pixel pitch in the orthogonal (or vertical) direction may, but need not, also be Δx.

A digital color image includes a plurality of image pixels and each of the plurality of image pixels is made of a combination of colors. The color of an image pixel can be represented by coefficients in a three-dimensional (3D) coordinate system. For example, each image pixel of a digital color image can be represented by a number of coefficients (such as three or four) in a color space (e.g., standard RGB (sRGB) color space, International Commission on Illumination (CIE) XYZ color space, etc.). The coefficients can represent weights or levels for each of the color channels that make up the color space. For example, in various implementations, the coefficients can represent each of the three color channels red (R), green (G), and blue (B) in the sRGB color space. As another example, the coefficients can represent the color channels cyan (C), magenta (M), yellow (Y) and black (K) in a color space that uses CMYK color model. For further discussion of FIG. 9A, consider that the input image is a 3D data array with RGB values at each spatial location. Such an input image can be displayed on a display device similar to the display device illustrated in FIG. 9A by mapping the 3D input image data array onto the array of pixels 900. Mapping the 3D input image array on to the array of pixels 900 includes assigning a value for each pixel in the color space associated with the display device.

A high-tonescale-resolution color image can have a number of bits ‘n’ representing each color channel making up the image pixel. In various implementations, the number of bits ‘n’ can be 2, 4, 8, 16 or 24. When a high-tonescale-resolution image (such as an image having 8, 16 or 24 bits per color channel) is displayed on a pixel array (for example, the pixel array 900 of FIG. 9A) having lower color resolution, each color channel may be quantized to reduce the number of color levels to, for example, 2 or 4 bits per color channel. The associated quantization error can be distributed to the color channels in neighboring pixels displaying substantially the same color according to an error diffusion algorithm. Examples of error diffusion algorithms include Floyd-Steinberg error diffusion and Jarvis error diffusion.

FIG. 9B shows an example method of distributing quantization error to color channels displaying the same color in neighboring pixels. In the illustrated example method, the color displayed by the red channel of pixel 905 is being quantized and the associated quantization error is diffused to the red channels of neighboring pixels 902, 903, 906 and 907. The amount of quantization error that is diffused to each of the neighboring pixels 902, 903, 906 and 907 can be calculated according to various error diffusion algorithms. One algorithm for diffusing the quantization error to neighboring pixels is the Floyd-Steinberg algorithm. In this algorithm, the image is scanned from left to right and top to bottom, quantizing the pixel values one by one. Each time the quantization error is transferred to the neighboring pixels to the right and the bottom, while not affecting the pixels that already have been quantized, for example, the pixels to the left and the top. The algorithm diffuses the quantization error of a pixel to its neighboring pixels, according to the distribution:

$$\frac{1}{16} [ \begin{matrix}0 & 0 & 0 \\ 0 & \# & 7 \\ 3 & 5 & 1\end{matrix} ] ,$$

where, the pixel being quantized is represented by ‘#’. Thus, in the example illustrated in FIG. 9B, if quantization error were diffused according to the Floyd-Steinberg algorithm, then 7/16th of the quantization error would be diffused to pixel 906 to the right of the pixel 905 which is being quantized as indicated by arrow 910; 3/16th of the quantization error is diffused to pixel 907 to the bottom-left of the pixel 905 which is being quantized as indicated by arrow 911; 5/16th of the quantization error is diffused to pixel 902 directly below the pixel 905 which is being quantized as indicated by arrow 913; and 1/16th of the quantization error is diffused to pixel 903 to the bottom-right of the pixel 905 which is being quantized as indicated by arrow 912. Other algorithms such as the Jarvis algorithm can also be used to diffuse the quantization error to color channels displaying the same color in the neighboring pixels.

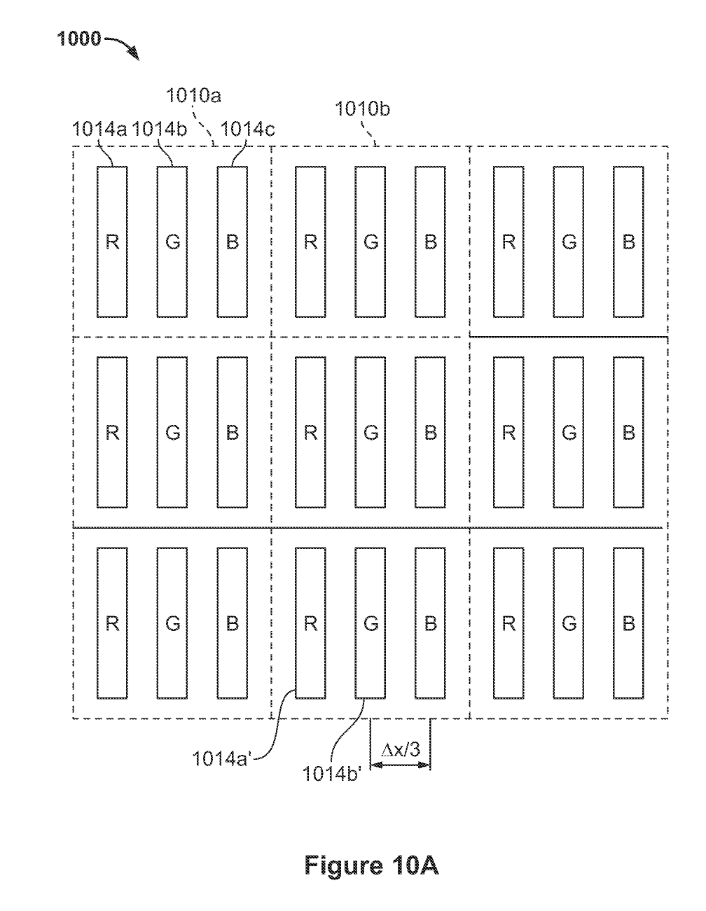

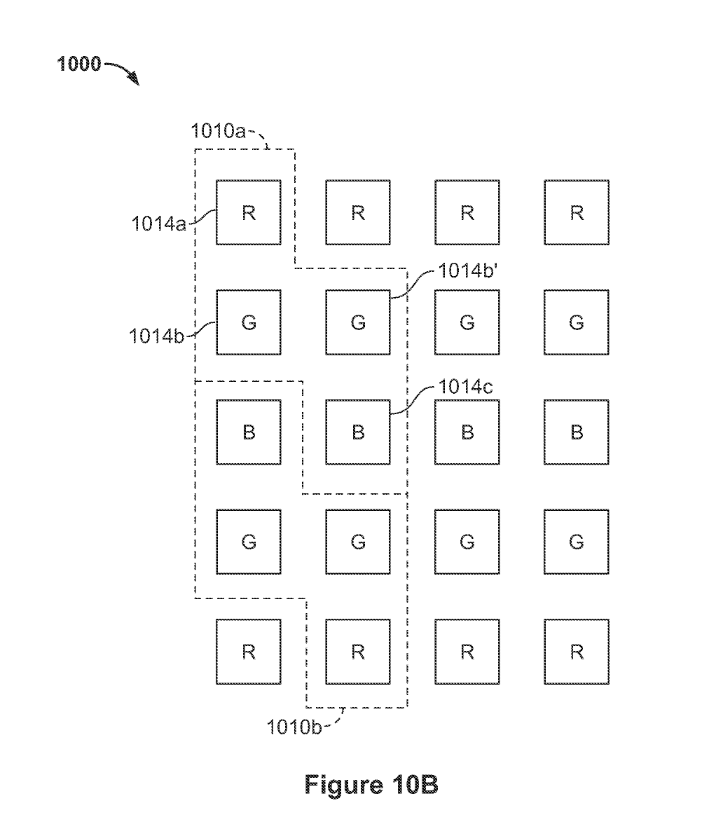

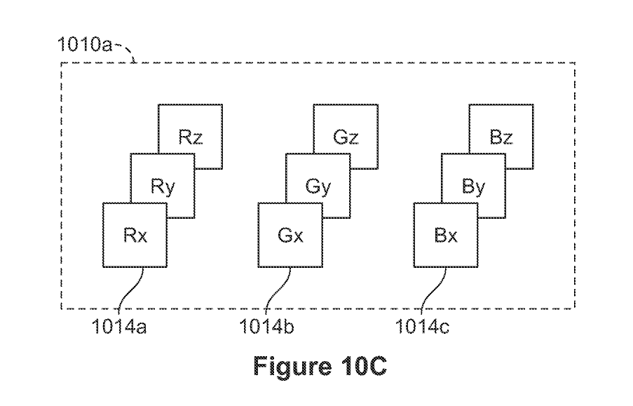

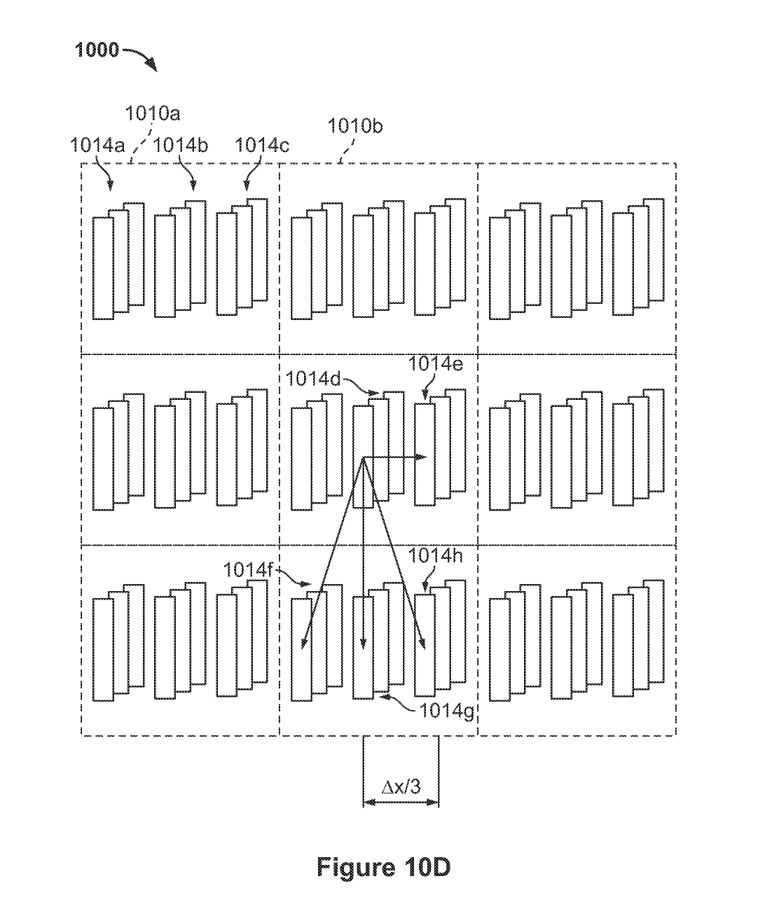

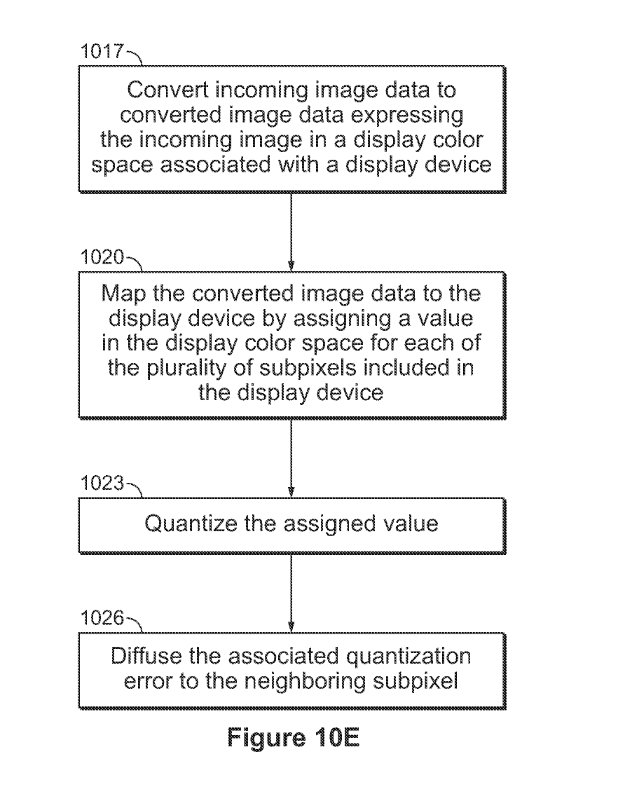

FIGS. 10A and 10B show examples of display devices including a plurality of pixels, each pixel including a plurality of subpixels. Two representative pixels 1010a and 1010b of the pixel array 1000 are indicated in FIG. 10A. Each pixel can include a plurality of subpixels. For example, the pixel 1010a in FIG. 10A includes subpixels 1014a, 1014b, and 1014c. The pixel 1010a in FIG. 10B includes subpixels 1014a, 1014b, 1014b′, and 1014c. The pixel array 1000 illustrated in FIG. 10A may be similar to the pixel array 900 illustrated in FIG. 9A such that the pixel pitch of the pixel array 1000 may be Δx. If the pixels 1010a and 1010b are assumed to be square, then the subpixel pitch (for example between subpixels 1014a′ and 1014b′) in FIG. 10A is approximately Δx/3 in the horizontal direction.

In various implementations pixels can represent the smallest unit of a display device that is configured to display the entire gamut of the display color space. In various implementations each of the subpixels of a pixel can represent a portion of the pixel that is configured to display a color in the gamut of the display color space. The shape or layout of the individual display pixels (for example 1010a and 1010b) and/or the number of subpixels (e.g. 1014a, 1014b, 1014c, 1014a′ and 1014b′) included in each pixel can be different in different implementations. For example, in various implementations, the pixels can be arranged in a square or a rectangular array as illustrated in FIGS. 9A and 10A, each pixel including three subpixels (e.g. 1014a, 1014b and 1014c). In the example illustrated in FIG. 10A, the subpixel 1014a is configured to display red color; the subpixel 1014b is configured to display green color; and the subpixel 1014c is configured to display blue color. The subpixels are arranged such that the red subpixels, subpixel 1014a being a representative example, are arranged in a first column, the green subpixels, subpixel 1014b being a representative example are arranged in a second column, and the blue subpixels, subpixel 1014c being a representative example are arranged in a third column.

In various other implementations, the pixels can be arranged in an “offset quad” geometry as illustrated in FIG. 10B, each pixel including four subpixels (e.g. 1014a, 1014b, 1014b′ and 1014c). In the example illustrated in FIG. 10B, the subpixel 1014a is configured to display red color; the subpixel 1014b is configured to display a first green color; the subpixel 1014b′ is configured to display a second green color; and the subpixel 1014c is configured to display blue color. The subpixels are arranged such that the red subpixels, subpixel 1014a being a representative example are arranged in a first row, the green subpixels, subpixels 1014b and 1014b′ being representative examples are arranged in a second row, and the blue subpixels, subpixel 1014c being a representative example are arranged in a third row. One possible advantage of arranging the subpixels in the manner illustrated in FIG. 10B is that the subpixels can be driven more efficiently by a row driver associated for each row of subpixels. Other pixel geometries such as triangular or hexagonal, with each pixel having three, four, six or more subpixels, are also possible.

As discussed above, the subpixels can be considered to represent a porion of the subpixel that displays a portion of gamut of the display color space or a color in the gamut of the display color space. For example, in the implementation illustrated in FIG. 10A, subpixel 1014a is configured to display red color (R); subpixel 1014b is configured to display green color (G); subpixel 1014c is configured to display blue color (B). In various implementations, each of the subpixels 1014a, 1014b, 1014c, 1014a′ and 1014b′ may be configured to display black (K) when the subpixel is turned off and one of two colors in the gamut of the display color space when the subpixel is turned on to one of two “on” states. In various implementations, each of the subpixels may be configured to display black (K) when the subpixel is turned off and one of three or more colors from the gamut of the display color space when the subpixel is turned on. In various implementations, the subpixels 1014a, 1014b, 1014c, 1014a′ and 1014b′ may be configured to display black (K), one or more colors from the gamut of the display color space, and white (W).

In various implementations, the colors displayed by the subpixels 1014a, 1014b, 1014c, 1014a′ and 1014b′ can be selected from a set of colors (for example red, green and blue; cyan, magenta and yellow; etc.) from the gamut of the color space which when combined can display white (W). In various implementations, the colors displayed by the subpixels 1014a, 1014b, 1014c, 1014a′ and 1014b′ can be selected from a set of primary colors (e.g., red, green and blue) which when combined can display white (W). In various implementations, each of the subpixels included in a single pixel 1010a and 1010b may display a color that is different from the neighboring subpixel. For example, in FIG. 10B, in pixel 1010a, subpixel 1014a may be configured to display a red color; subpixel 1014b may be configured to display a first green color, subpixel 1014b′ may be configured to display a second green color different from the first green color and subpixel 1014c may be configured to display a blue color. As used herein, the word “color” is used in a broad sense and may include any attribute or representation of a point in a color space. For example, a color may be represented in terms of one or more of the following: hue, chroma, saturation, value, brightness, lightness, luminance, correlated color temperature, dominant wavelength, or coordinate(s) in a color space (e.g., sRGB, CIELAB, etc.). A subpixel that displays a different color than another subpixel may have, for example, a different hue, a different saturation or a different brightness than the color displayed by the other subpixels.

As discussed above, in various other implementations, the number of subpixels included in each pixel can be different from the number of subpixels illustrated in FIGS. 10A and 10B and discussed here. In various other implementations, the color displayed by each of the subpixels can be different from colors illustrated in FIGS. 10A and 10B and discussed here. When mapping the image pixel of a color image to a display device similar to the display device illustrated in FIGS. 10A and 10B, each of the subpixels 1014a-1014c is configured to display a particular color such that the color combination displayed by the display pixel 1010a and 1010b closely matches the color combination of the image pixel at that spatial location.

In various implementations, the color of a pixel can be represented in a device-independent color space, for example, the CIEXYZ color space. In various implementations, the color of a pixel can be represented in a perceptually uniform color space (e.g. CIE 1976 (L*,u*,v*) (CIELUV) color space, the CIE 1976 (L*,a*,b*) (CIELAB) color space), in which a change of the same amount in a color value produces a change of about the same visual appearance. In various implementations, the color of a pixel can be represented in other device-independent color spaces, for example, sRGB, YCbCr, etc.

FIG. 10C shows an example representation of a pixel in the XYZ color space. In the XYZ color space, the color for each subpixel has corresponding X, Y, and Z tristimulus values in the device-independent color space. In FIG. 10C, each subpixel is associated with its own XYZ values. For example, subpixel 1014a which is configured to display a red color is associated with a first set of XYZ values corresponding to Rx, Ry and Rz; subpixel 1014b which is configured to display a green color is associated with a second set of XYZ values corresponding to Gx, Gy and Gz; and subpixel 1014c which is configured to display a blue color is associated with a third set of XYZ values corresponding to Bx, By and Bz.

To display an image on a display device including a plurality of subpixels 1014a, 1014b, 1014c, 1014a′ and 1014b′ similar to the display device illustrated in FIGS. 10A and 10B, a processor associated with the display device can be configured to quantize each of the XYZ values associated with each subpixel to reduce the color depth and diffuse the associated quantization error for each of the XYZ values to the neighboring subpixels.

FIG. 10D shows an example method of distributing quantization error to neighboring subpixels. In the illustrated method, consider that the XYZ values associated with subpixel 1014d are X₁, Y₁ and Z₁. The illustrated method would quantize the values X₁, Y₁ and Z₁ and diffuse the associated quantization errors ΔX₁, ΔY₁ and ΔZ₁ to the neighboring subpixels 1014e, 1014f, 1014g and 1014h (or to color channels of neighboring pixels) that have not yet been processed, similar to the method for diffusion to neighboring pixels illustrated in FIG. 9B. The proportion in which the quantization errors ΔX₁, ΔY₁ and ΔZ₁ are diffused to the neighboring subpixels can be determined from the error diffusion algorithm used. For example, if the Floyd-Steinberg error diffusion algorithm is used, then 7/16th of the quantization errors ΔX₁, ΔY₁ and ΔZ₁ would be diffused to subpixel 1014e; 3/16th of the quantization errors ΔX₁, ΔY₁ and ΔZ₁ would be diffused to subpixel 1014f; 5/16th of the quantization error is diffused to subpixel 1014g; and 1/16th of the quantization error is diffused to subpixel 1014h.

In other implementations, the quantization error for a subpixel could be transferred to a different number and/or arrangement of neighboring subpixels (for example, Jarvis error diffusion could be used). In some methods of diffusing the quantization error on a subpixel level, the neighboring subpixel (e.g., subpixels 1014e, 1014f or 1014h in FIG. 10D) to which the error is diffused can display a color that is substantially different from the color displayed by the subpixel being quantized (for example, subpixel 1014d in FIG. 10D). As discussed above and without any loss of generality, the color displayed by the neighboring subpixel can have a different hue, a different saturation, a different brightness, or any combination of hue, saturation, and brightness. For example, if the color displayed by the subpixel being quantized is red, then the neighboring subpixel to which error is diffused can display a different hue (for example, green or blue), a different saturation (for example, a lighter or a darker of red) or a different brightness (for example, brighter red).

FIG. 10E illustrates a flowchart that describes an example method of performing error diffusion on a subpixel array. The subpixel array can be included in a display device similar to the display device illustrated in FIGS. 10A and 10B. The example method can be performed by a processor that is associated with the display device. At block 1017, incoming image data is converted to converted image data. Converting the incoming image data includes expressing the color information of the incoming image data in a display color space which is associated with the display device. In various implementations, the display color space can include a color space that is de-saturated with respect to the sRGB color space. At block 1020, the converted image data is mapped to the display device by assigning a value in the display color space for each of the plurality of subpixels (e.g. 1014a, 1014b, 1014c, 1014a′ and 1014b′) included in the display device. In various implementations, the mapping process can include determining the tristimulus X, Y and Z values corresponding to the colors to be displayed by each subpixel. At block 1023, the values assigned to each subpixel are quantized. In various implementations, each of the tristimulus X, Y and Z values associated with each subpixel can be quantized. The quantization process can be associated with a quantization error. The associated quantization error can be diffused to one or more neighboring pixels as indicated in block 1026. In various implementations, the value assigned to each subpixel can be converted to a device independent color space before quantization. In various implementations, the device independent color space can be a perceptually uniform color space.

This method of processing an image can increase the spatial and/or tone-scale resolution of the displayed images and/or enhance the sharpness of the displayed image. In various implementations, the method of diffusing quantization error described above can be used in display devices having a device color space that is de-saturated with respect to a standard color space, for example, sRGB color space.

Although, the method illustrated in FIGS. 10D and 10E and described above performs the error diffusion in the display XYZ color space, this method of diffusing the error on a subpixel level can be extended to any desired color space such as, for example, the display device color space, the CIEXYZ color space, the CIELAB color space and so forth. Different error diffusion schemes may diffuse the error to different sets of neighboring pixels or subpixels (known as the “support” for the diffusion scheme) and/or with different weights (for example, the amount of the total quantization error that is diffused to a particular subpixel in the support).

As discussed above, in various implementations, the pixel pitch of the array illustrated in FIG. 10A may be Δx and the subpixel pitch may be Δx/3 if the pixels 1010a and 1010b are assumed to be square. Performing error diffusion in the subpixel array can increase horizontal spatial resolution since the quantization error is distributed over shorter distances (for example, Δx/3 in subpixel space rather than Δx in pixel space), thus providing an illusion of a continuous-tone image.

In addition to an increase in horizontal spatial resolution, an increase in vertical spatial resolution may also be gained for certain display device architectures.

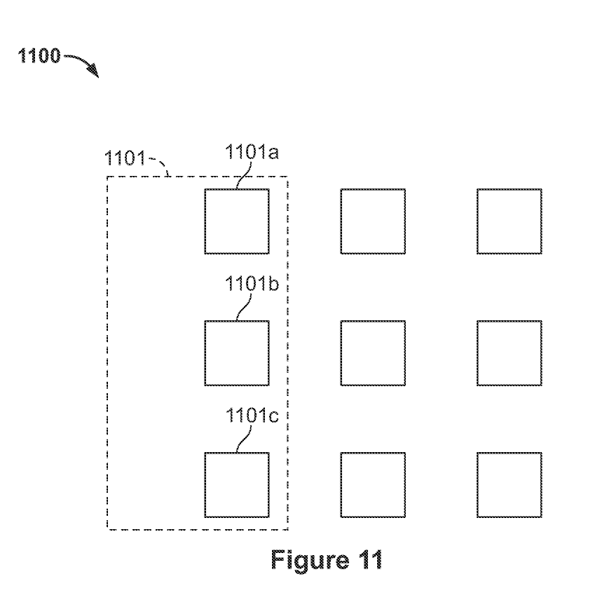

FIG. 11 shows an example of a cross-section of an implementation of a display device 1100 including an array of electromechanical systems devices. Three representative subpixels 1101a, 1101b and 1101c are indicated. In various implementations, each of the subpixels 1101a, 1101b and 1101c reflects a certain color. Groups of subpixels 1101a, 1101b and 1101c can represent a pixel 1101 of the display device 1100. In various implementations, each of the subpixels 1101a, 1101b and 1101c can include one or more electromechanical systems devices that have movable mirror elements (for example, the movable reflective layer 14 illustrated in FIG. 1). In some implementations, each of the subpixels 1101a, 1101b and 1101c can include interferometric modulators that interferometrically modulate light to produce a desired spectral reflectivity.

In various implementations, each display subpixel, for example the subpixel 1101a, may include multiple (for example, three) distinct movable mirror elements or interferometric modulators. In various implementations, the interferometric modulator may include a movable mirror element (for example, a reflective layer) that can be actuated between two positions such that the interferometric modulator appears non-reflective (in the visible range, for example, dark or black) in one state and reflective (e.g., a desired color for the subpixel) in another state. In some implementations, the movable mirror element can be actuated among three or more positions so that the interferometric modulator can have three or more states, for example, non-reflective (in the visible range, for example, dark or black) and two or more reflective states (for example, two or more colors).

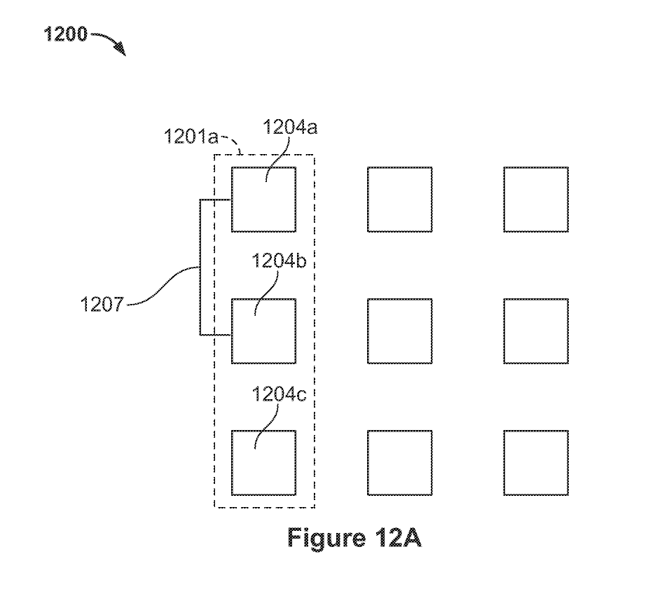

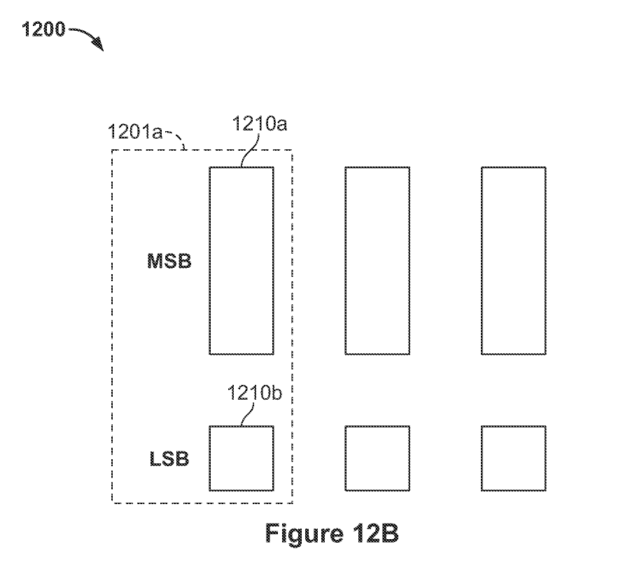

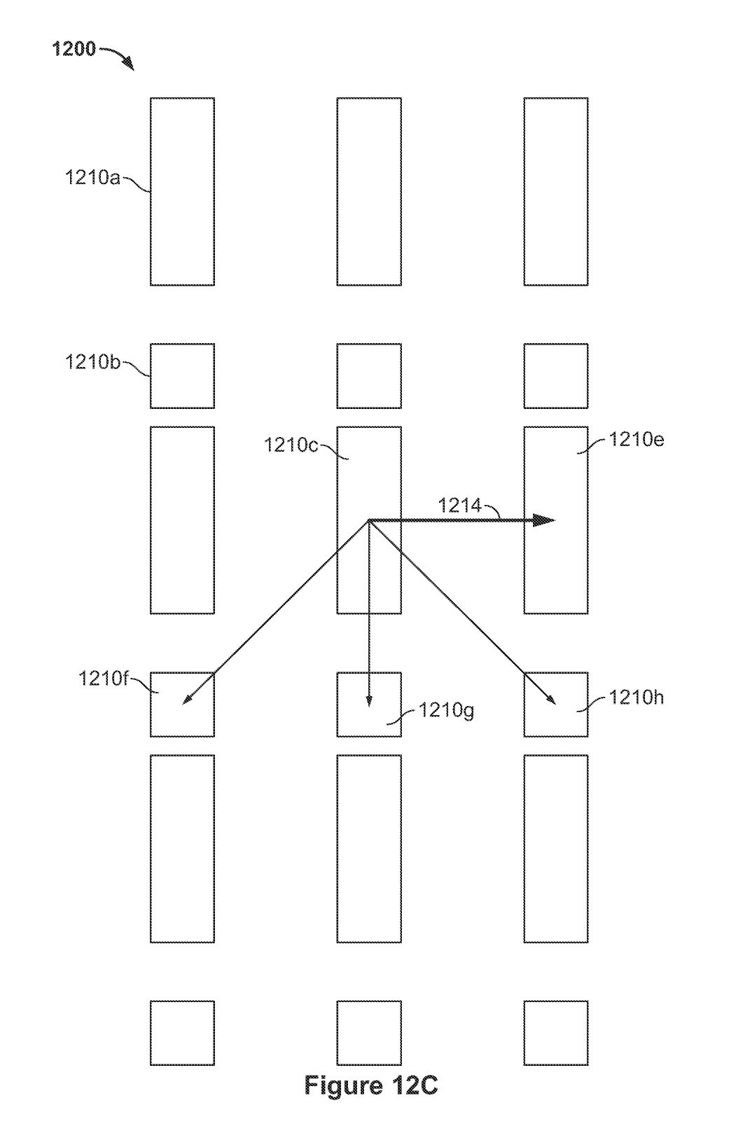

FIGS. 12A and 12B show an example of a display device that can display 2-bit color. In various implementations, the display device illustrated in FIGS. 12A and 12B can be an electromechanical systems device 1200, with movable mirror elements 1204a, 1204b and 1204c, having a color depth of 2-bits per color channel. One representative 2-bit subpixel 1201a or color channel is indicated. In the example implementation illustrated in FIG. 12A, each 2-bit subpixel (for example, 1201a) includes three movable mirror elements 1204a, 1204b and 1204c, two of which (for example, 1204a and 1204b) can be coupled together so that they can be electrically activated or deactivated together. These two coupled or “ganged” mirror elements are shown by connector 1207 and can be used to form the most significant bit (MSB) of the 2-bit color palette. The third reflector (for example, 1204c) forms the least significant bit (LSB) of the 2-bit color palette. Thus, each subpixel 1201a can be considered to have two reflectors 1210a and 1210b as illustrated in FIG. 12B. Since the movable mirror element 1210a is formed by coupling two movable mirror elements 1204a and 1204b, it can be considered to have a reflective area greater than the area of the movable mirror element 1210b. In various implementations, the reflective area of the movable mirror element 1210a can be approximately two times the reflective area of the movable mirror element 1210b. In various implementations, the area of the movable mirror element 1210a can be approximately three times the area of the movable mirror element 1210b. In other implementations the ratio between the areas of the movable mirror elements 1210a and 1210b can be 4, 5, 10, 20, etc. In the example shown in FIG. 12B, the movable mirror element 1210a forms the MSB and contributes ⅔rd of the total subpixel color space (for example, XYZ) values and the movable mirror element 1210b forms the LSB contributes the remaining ⅓rd of the total subpixel color space values.

The resulting display device 1200 including an array of movable mirror elements is schematically shown in FIG. 12C. Seven representative movable mirror elements 1210a, 1210b, 1210c, 1210d, 1210e, 1210f, 1210g, and 1210h are indicated in FIG. 12C. The resulting display device 1200 can be considered to be a “sea of mirrors”, and the possible colors displayed by each movable mirror element in the “sea of mirrors” defining the display color space. In various implementations, the XYZ values of the array of movable mirror elements (e.g. 1210a, 1210b, 1210c, 1210d, 1210e, 1210f, 1210g and 1210h) can define the color space associated with the display device 1200.

FIG. 12C shows an example method of distributing quantization error to neighboring subpixels in a display device that can display 2-bit color. The illustrated method can be similar to the method described with reference to FIGS. 10D and 10E. The incoming image data can be displayed by mapping the input 3D image array on the array of movable mirror elements 1210a, 1210b, 1210c, 1210d, 1210e, 1210f, 1210g and 1210h. The mapping can be performed by finding the XYZ values for each movable mirror element 1210a, 1210b, 1210c, 1210d, 1210e, 1210f, 1210g and 1210h that would be the closest to the color to be displayed at that spatial location. In various implementations, these XYZ values can be transformed to any other suitable color space, for instance, CIELAB, YCbCr, etc. The XYZ values in the device color space or in any other color space are then quantized to reduce the color depth and the error associated with the quantization is distributed to the neighboring movable mirror elements 1210a, 1210b, 1210c, 1210d, 1210e, 1210f, 1210g and 1210h according to an error diffusion algorithm. The error diffusion algorithm can be any of the standard algorithms known in the art, for example, Floyd-Steinberg, Jarvis, etc. In various implementations, the error may be diffused to the different movable mirror elements with different weights. The weights associated with diffusing the error may correspond to the area of the movable mirror element. For example, in FIG. 12C, the amount of error diffused may be weighted such that amount of error that is diffused to the movable mirror element 1210e, which has a larger area than the other elements (such as movable mirror elements 1210f, 1210g and 1210h) and which represents the MSB, is greater than the amount of error diffused to the movable mirror elements 1210f, 1210g and 1210h which represent the LSB as indicated by the thicker arrow 1214. In various implementations, the amount of error diffused may be proportional to the area or some other dimension (for example, width or length) of the movable mirror elements. This method of diffusing quantization error to an adjacent movable mirror element in a “sea of mirrors” can provide increased horizontal and vertical spatial resolution which can result in sharper images.

As discussed above, in some implementations, the XYZ values in the display color space associated with each movable mirror element 1210a, 1210b, 1210c, 1210d, 1210e, 1210f, 1210g and 1210h are transformed to a perceptually uniform color space. In some implementations, transforming the display color space values to a perceptually uniform color space can include separating brightness, hue and saturation channels. In some implementations, performing error diffusion in perceptually uniform color space can include diffusing error in the brightness channel with a higher weight as compared to diffusing error in the hue channel. This method of diffusing error may yield better visual results since human vision better perceives small differences of brightness in small local areas, than similar differences of hue in the same area, and even more than similar differences of saturation on the same area. For example, if there is a small error in the green channel that cannot be represented, and another small error in the red channel in the same pixel, the properly weighted sum of these two errors may be used to adjust a perceptible brightness error, that can be represented in a balanced way between all three color channels (according to their respective statistical contribution to the brightness), even if this produces a larger error for the hue when converting the green channel. This error will be diffused in the neighboring pixels.

In some implementations, the XYZ values in the display color space may be transformed to a CIELAB color space. In some of these implementations, a linearized form of the color space is used, in which certain nonlinear functions (for example, a cube root) in the conversion from XYZ to CIELAB coordinates is not applied.

If the error diffusion is done in the display color space, the quantized and the error diffused colors can be mapped back into the device color space and then applied to the subpixels of the display device by a device driver.

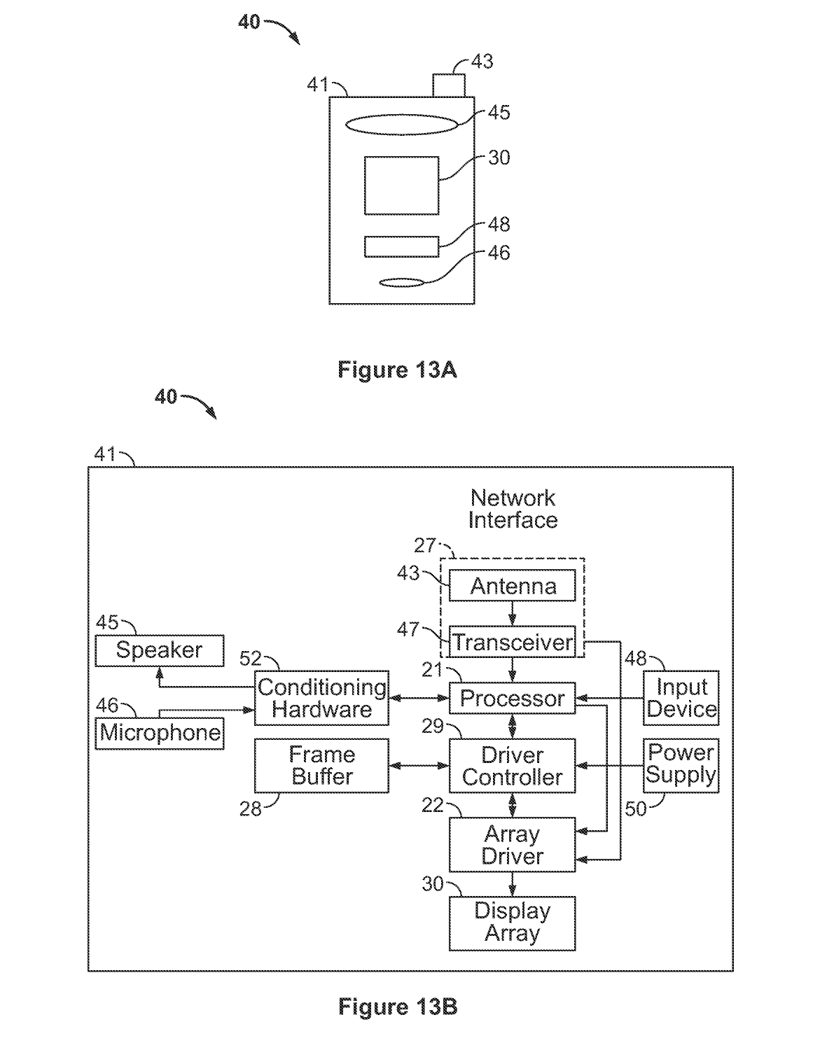

FIGS. 13A and 13B show examples of system block diagrams illustrating a display device 40 that includes a plurality of interferometric modulators. In various implementations, the display device 40 can be similar to the display device 1200 illustrated in FIGS. 12A-12C. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level. In various implementations, the processor 21 may be configured to convert the image data to converted image data expressing the image data in a display color space associated with the display device 40. In various implementations, the processor 21 may be configured to convert the image data to express the image data in device independent color space. In various implementations, the processor 21 may be configured to implement the method for diffusing quantization error described above either completely or partially.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22. In various implementations, the driver controller 29 can implement the quantization error diffusion method described here by executing instructions from the processor.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure-sensitive or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a reflective display device including a plurality of pixels, each pixel including a plurality of subpixels, each of the plurality of subpixels configured to display black and at least one color in a display color space associated with the display device; and
a processor configured to communicate with the display device and to process incoming image data, the processor further configured to:
convert the incoming image data to converted image data expressing the incoming image in the display color space;
map the converted image data to the plurality of subpixels by assigning a value for each of the plurality of subpixels; and
for each subpixel:
quantize the value, the quantization associated with a quantization error for each subpixel; and
diffuse the quantization error to one or more neighboring subpixels that display a color different from the color displayed by the subpixel to provide a diffused quantized color value for the one or more neighboring subpixels.

2. The apparatus of claim 1, wherein each pixel includes at least three subpixels.

3. The apparatus of claim 1, wherein each pixel includes four subpixels.

4. The apparatus of claim 1, wherein each subpixel includes at least two movable mirror elements.

5. The apparatus of claim 4, wherein the at least two movable mirror elements have different reflective areas.

6. The apparatus of claim 5, wherein the processor is configured to diffuse the quantization error to one or more neighboring subpixels based at least in part on the reflective areas of the at least two movable mirror elements in the respective neighboring subpixels.

7. The apparatus of claim 1, wherein each subpixel is configured to display two bits per color channel.

8. The apparatus of claim 7, wherein the incoming image data has eight bits per color channel, and the processor is further configured to convert the incoming image data to two bits per color channel.

9. The apparatus of claim 1, wherein the color displayed by each of the plurality of subpixels is selected from a set of colors which when combined displays white.

10. The apparatus of claim 1, wherein each of the plurality of subpixels is configured to display black and two or more colors.

11. The apparatus of claim 1, wherein each of the plurality of subpixels is configured to display black, white, and three or more colors.

12. The apparatus of claim 1, wherein the value assigned for each of the plurality of subpixels is converted to a first color space before quantization.

13. The apparatus of claim 12, wherein the first color space includes a perceptually uniform color space.

14. The apparatus of claim 13, wherein the perceptually uniform color space includes a linearized CIELAB color space.

15. The apparatus of claim 12, wherein the diffused quantized color values in the first color space are converted to the display color space.

16. The apparatus of claim 1, wherein the processor is configured to diffuse the quantization error to one or more neighboring subpixels that display a color having a different hue from the color displayed by the subpixel.

17. The apparatus of claim 1, wherein the processor is configured to diffuse the quantization error to one or more neighboring subpixels that display a color having a different saturation from the color displayed by the subpixel.

18. The apparatus of claim 1, wherein the processor is configured to diffuse the quantization error to one or more neighboring subpixels that display a color having a different brightness from the color displayed by the subpixel.

19. The apparatus of claim 1, further comprising a memory device that is configured to communicate with the processor.

20. The apparatus of claim 19, further comprising a driver circuit configured to send at least one signal to the display device.

21. The apparatus of claim 20, further comprising a controller configured to send at least a portion of the image data to the driver circuit.

22. The apparatus of claim 1, further comprising an image source module configured to send the image data to the processor.

23. The apparatus of claim 22, wherein the image source module includes at least one of a receiver, transceiver, and transmitter.

24. The apparatus of claim 1, further comprising an input device configured to receive input data and to communicate the input data to the processor.

25. An apparatus comprising:
a reflective display device including a plurality of pixels, each pixel including a plurality of subpixels, each of the plurality of subpixels configured to display black and a color in a color space associated with the reflective display device, the display device configured to display an image data by mapping the image data to the plurality of subpixels;
means for quantizing the mapped image data, the quantization associated with a quantization error for each subpixel; and
means for diffusing the quantization error to one or more neighboring subpixels that display a color different from the color displayed by the subpixel.

26. The apparatus of claim 25, wherein the reflective display device includes at least one interferometric modulator.

27. The apparatus of claim 25, wherein the quantizing means includes a processor configured to communicate with the reflective display device.

28. The apparatus of claim 25, wherein the diffusing means includes a processor configured to communicate with the reflective display device.

29. A method for diffusing quantization error in a display device, the method comprising:
converting incoming image data to converted image data expressing the incoming image in a display color space associated with a display device, the display device including a plurality of pixels, each pixel including a plurality of subpixels, each of the plurality of subpixels configured to display black and at least one color in the display color space;
mapping the converted image data to the plurality of subpixels by assigning a value in the display color space for each of the plurality of subpixels;
quantizing the assigned value, the quantization associated with a quantization error for each subpixel; and
diffusing the quantization error to one or more neighboring subpixels that display a color different from the color displayed by the subpixel to provide diffused quantized color values for the one or more neighboring subpixels.

30. The method of claim 29, further comprising converting the assigned value for each of the plurality of subpixels to a first color space prior to quantizing the assigned value.

31. The method of claim 30, wherein the first color space includes a perceptually uniform color space.

32. The method of claim 29, further comprising converting the diffused quantized color values to the display color space.

33. The method of claim 29, wherein diffusing the quantization error comprises diffusing the quantization error to one or more neighboring subpixels that display a color having one or more of: a different hue, a different saturation, or a different brightness from the color displayed by the subpixel.
